(19) United States
(12) Patent Application Publication
(10) Pub. No.: US 2025/0357836 A1
(43) Pub. Date: Nov. 20, 2025

(54) DRIVE EXCITER AND ELECTRONIC DEVICE

(71) Applicant: Goertek Inc., Weifang, Shandong (CN)

(72) Inventors: Hiroyuki KOBAYASHI, Shandong (CN); Tomokuni Wauke, Shandong (CN); Haiyang Ding, Shandong (CN)

(73) Assignee: Goertek Inc., Weifang, Shandong (CN)

(21) Appl. No.: 18/870,885

(22) PCT Filed: Nov. 4, 2022
(86) PCT No.: PCT/CN2022/130023

§ 371 Date: Dec. 2, 2024

(30) Foreign Application Priority Data
May 31, 2022 (CN) 202210609357.4

(51) Int. Cl. H02K 33/02; H02K 7/10

(52) U.S. Cl. CPC H02K 33/02; H02K 7/10

(57) ABSTRACT

The present disclosure discloses a drive exciter and an electronic device. The drive exciter includes a bracket, a vibration part, a braking part and a latch part, and the bracket includes an installation member and a guiding structure connected to the installation member; the vibration part is movably connected to the guiding structure and is provided with a vibratile vibration member; the braking part includes a first end and a second end, the first end is connected to the vibration part, and the second end is connected to the installation member; the latch part includes a driving member connected to the installation member and a latch member connected to an output end of the driving member; the drive exciter has a first state where the latch member abuts against the vibration part and a second state where the latch member is disengaged from the vibration part; and in the second state, the vibration part moves towards the installation member, and the first end interacts with the second end so that the first end is separated from the second end.

### CROSS-REFERENCE TO RELATED APPLICATIONS

The present disclosure is a National Stage of International Application No. PCT/CN2022/130023, filed on Nov. 4, 2022, which claims priority to a Chinese patent application No. 202210609357.4 filed with the CNIPA on May 31, 2022, both of which are hereby incorporated by reference in their entireties.

### TECHNICAL FIELD

The present disclosure relates to the technical field of a vibration apparatus, and particularly to a drive exciter and an electronic device.

### BACKGROUND

As a means of reproducing force sensations, there is now a method that involves inputting an asymmetric signal to a linear resonator and using the human senses to generate an illusion of a force “seemingly directed in a certain direction”. This method can, in principle, only produce a continuous directional force sensation and cannot achieve discrete vibration outputs, and the range of change in the force sensation is limited. Additionally, the asymmetric signal also generates excessive vibrations and cannot produce a pure directional output, and therefore, the leading to a blurred sense of direction and low efficiency in the vibrations obtained by the above method.

In addition, the linear resonator or the exciter adopting the method still employs damping materials such as a spring and the like for braking or resetting, i.e., these functions are achieved through solid contact. When using solid contact, a steep reaction force generated during contact can cause rebound if the elasticity of the material is very strong, resulting in non-anisotropic vibration of the particles. If the damping characteristics of the material are too high, the kinetic energy of the braked particles will be converted into thermal energy, increasing energy loss and reducing efficiency. Furthermore, wear and deformation of the contact surfaces are inevitable, making it difficult to ensure the long-term stability of the structure.

The above content is provided solely to assist in understanding the technical solution of the present disclosure and does not represent an admission that the above content constitutes prior art.

### SUMMARY

The main objective of the present disclosure is to provide a drive exciter, intended to improve the efficiency of the drive exciter and reduce loss of the hardware while discretely presenting the anisotropic vibration.

To achieve the above objective, the present disclosure proposes a drive exciter, including:
a bracket including an installation member and a guiding structure connected to the installation member;
a vibration part movably connected to the guiding structure and provided with a vibratile vibration member;
a braking part including a first end and a second end which are oppositely provided, the first end being connected to the vibration part, and the second end being connected to the installation member;
a latch part including a driving member connected to the installation member and a latch member connected to an output end of the driving member;
wherein the drive exciter has a first state where the latch member abuts against the vibration part and a second state where the latch member is disengaged from the vibration part; and in the second state, the vibration part moves towards the installation member, and the first end interacts with the second end so that the first end is separated from the second end.

In one embodiment, the first end is a first magnetic member, the second end is a second magnetic member, and polarities of their respective sides facing each other are opposite.

In one embodiment, a surface of the vibration part is provided with a boss, the first magnetic member is provided on the boss, the braking part is further provided with a magnetic yoke connected to the installation member, the magnetic yoke is provided with a magnetic shielding slot, and the second magnetic member is provided in the magnetic shielding slot:
and/or, both the first magnetic member and the second magnetic member are permanent magnets.

In one embodiment, the braking part is an air spring, with two ends thereof forming the first end and the second end respectively.

In one embodiment, the installation member includes:
an installation body provided with an installation slot and a clearance hole provided on a bottom wall of the installation slot, the guiding structure being connected to the installation body; and
a coverplate sealing a rabbet of the installation slot and removably connected to the installation body, the second end being fixedly connected to the coverplate through the clearance hole.

In one embodiment, the latch part includes two latch members, which are located on both sides of the vibration part to form a limiting space, and the driving member is connected to at least one of the latch members:
wherein in the first state, the vibration part is limited in the limiting space.

In one embodiment, the driving member is provided with a rotation shaft, with the latch member being a locking rod, one end of the latch member being connected to the rotation shaft, and a length direction of the latch member being arranged at an angle with an extension direction of the rotation shaft:
or, the driving member drives the latch member to move in a straight line, with a movement direction of the latch member arranged at an angle with a vibration direction of the vibration member.

In one embodiment, the guiding structure includes at least two guiderods extending along a vibration direction of the vibration member, and ends of the guiderods are fixed to the installation member:
the vibration part includes:
a housing provided with a shaft liner at a side surface thereof, the shaft liner being movably sleeved on the guiderod, the housing enclosing a vibration space, and the first end being connected to the housing;
a vibration member provided within the vibration space vibrationally; and
two spring leaves provided on both sides of the vibration member along the vibration direction of the vibration member, the spring leaves being connected to the housing and an end of the vibration member.

In one embodiment, the drive exciter further includes a resetting member which is a spring, two ends of which are elastically connected to surfaces of the vibration part and the installation member.

In one embodiment, the drive exciter includes two installation members opposite to each other, two braking parts opposite to each other, and two latch parts opposite to each other, with two ends of the guiding structure connected to the two installation members:
the two braking parts are oppositely provided on the two installation members;
two latch parts are provided in parallel on both sides of the vibration part, one driving member is connected to one latch member, and each latch member is provided between the vibration part and the installation member to form a limiting space;
wherein in the first state, the vibration part is limited in the limiting space.

The present disclosure further relates to an electronic device, which includes the drive exciter according to any one of the above embodiments.

The technical solution of the present disclosure can significantly increase the asymmetry of the anisotropic vibrations and present asymmetric vibrations discretely over a short period of time. Moreover, by generating vibrations that closely mimic the actual asymmetrical vibration force, it is possible to discretely present a clear force sensation in a certain direction within a short time. The direction of this force sensation depends on the direction in which the braking part abuts against the vibration part, thus not being limited to the manner of holding.

In addition, the present disclosure achieves braking of the vibration part through the interaction between the first end and the second end, thereby generating anisotropic vibrations. On one hand, the vibration part does not come into contact with the installation member, reducing hardware wear. On the other hand, solid contact braking tends to be short in time, but by adjusting parameters such as the material, shape, etc., of the first end and the second end, the present disclosure can achieve a longer braking time, resulting in diverse effects and presenting a clear sense of directional force with minimal unnecessary vibration.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic structural diagram of one embodiment of the drive exciter according to the present disclosure;

FIG. 2 is a partial schematic structural diagram of one embodiment of the drive exciter according to the present disclosure;

FIG. 3 is a schematic structural diagram of a vibration part of one embodiment of the drive exciter according to the present disclosure;

FIG. 4 is partial schematic structural diagram in another perspective of the vibration part in FIG. 3:

FIG. 5 is a schematic structural diagram of an installation part of another embodiment of the drive exciter according to the present disclosure:

FIG. 6 is a schematic structural diagram of a braking part of one embodiment of the drive exciter according to the present disclosure:

FIG. 7 is a schematic structural diagram of a braking part of another embodiment of the drive exciter according to the present disclosure;

FIG. 8 is a waveform diagram of an asymmetric signal for solid contact braking in the prior art;

FIG. 9 is a comparison chart of magnet repulsive force and spring resistance versus distance;

FIG. 10 is an effect diagram of solid contact braking in the prior art.

FIG. 11 is a braking effect diagram of one embodiment of the drive exciter according to the present disclosure;

FIG. 12 is a braking effect diagram of another embodiment of the drive exciter according to the present disclosure.

### DESCRIPTION OF REFERENCE SIGNS

| No. | Name | No. | Name |
|---|---|---|---|
| 100 | drive exciter | 34 | first linkage plate |
| 10 | bracket | 35 | second linkage plate |
| 11 | installation member | 37 | spring leaf |
| 111 | installation body | 40 | braking part |
| 111a | cleaning hole | 41 | first end |
| 113 | coverplate | 42 | second end |
| 13 | guiding structure | 43 | magnetic yoke |
| 131 | guiderod | 50 | latch part |
| 15 | first connecting rack | 51 | driving member |
| 17 | second connecting rack | 53 | latch member |
| 30 | vibration part | 55 | limiting member |
| 31 | housing | 55a | limiting slot |
| 311 | shaft liner | 55b | notch |
| 33 | vibration member | 60 | resetting member |

The realization of the purpose, functional features and advantages of the present disclosure will be further described in conjunction with the embodiments and with reference to the accompanying drawings.

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, front, rear . . . ) in the embodiments of the present disclosure is only used to explain the relative position relationship between the components under a particular attitude (as shown in the attached drawing), the motion, etc., and if the specific attitude changes, the directional indication will change accordingly.

In addition, descriptions involving “first”, “second”, etc., in the present disclosure are used solely for descriptive purposes and should not be construed as indicating or implying their relative importance or as implicitly specifying the number of the indicated technical features. Thus, features defined by “first”, “second”, etc., may explicitly or implicitly include at least one such feature. Furthermore, technical solutions from different embodiments can be combined, but must be based on what an ordinary skilled person in the art could achieve. When the combination of technical solutions results in mutual contradictions or impossibility of implementation, such combinations should be considered non-existent and outside the scope of protection claimed in the present disclosure.

The so-called “anisotropic vibration”, also known as “asymmetric vibration” creates a sensation for the user holding the vibration device of being pulled in a specific direction by inputting an asymmetrical signal to the vibration apparatus such as a vibration motor, etc. Moreover, vibration apparatuses capable of achieving anisotropic vibration are commonly used in devices such as game controllers and provide users with excellent feedback through asymmetric vibration.

In the vibration apparatus involved in the technical solution of the present disclosure, the so-called “discrete” is a concept that contrasts with “continuous”. For example, after a single excitation, the vibration motor will continuously vibrate to output a continuous vibration to the vibration apparatus, such that the user feels a vibration or pulling sensation that lasts for a period of time, it is referred to as the continuous vibration: however, if the vibration apparatus outputs a clear vibration directed towards a specific direction once or multiple times at intervals over a period, it is referred to as the discrete anisotropic vibration.

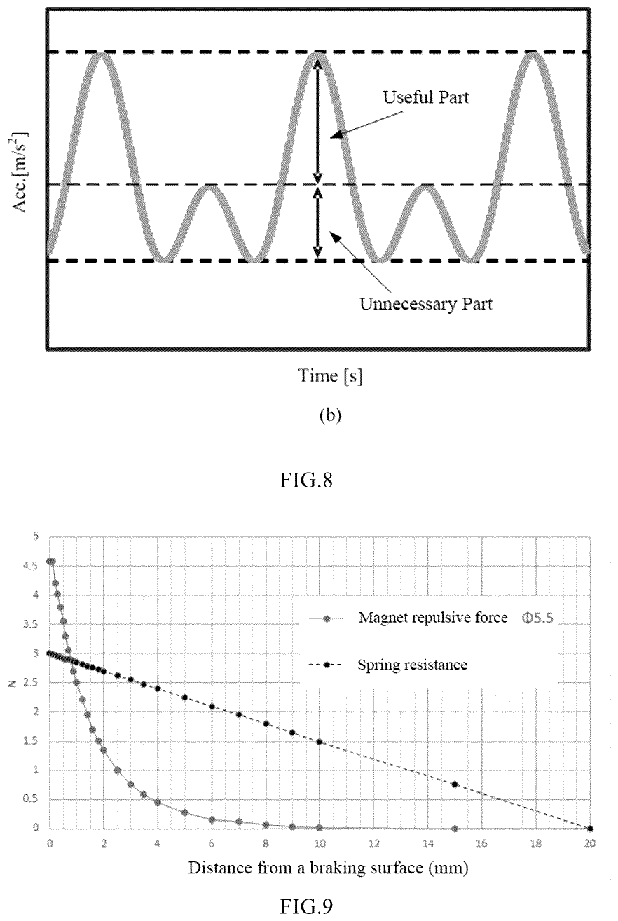

As shown in FIG. 8, both diagrams in FIG. 8 illustrate that the waveform repeats in a certain cycle, this is because the pseudo-force sensation effect of “pulling in a certain direction” is generated through an asymmetric waveform that repeats at a constant period. In addition to the part of the waveform that contributes to generating the force sensation, there are many unnecessary vibrations, making this method unsuitable for producing discrete force sensations.

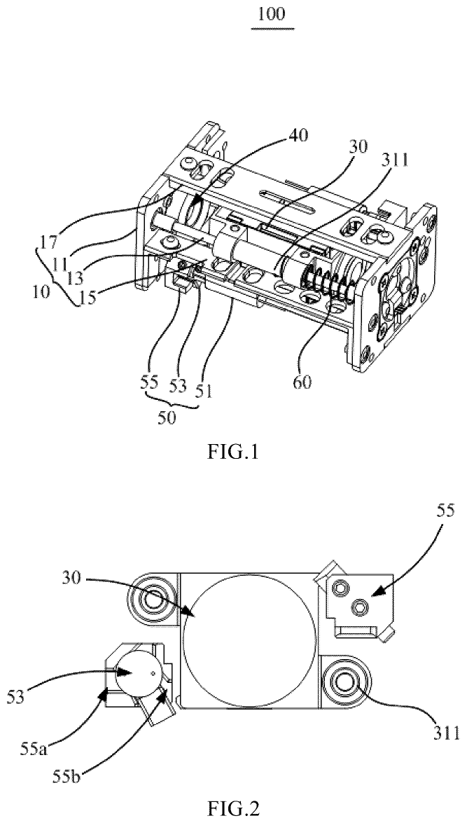

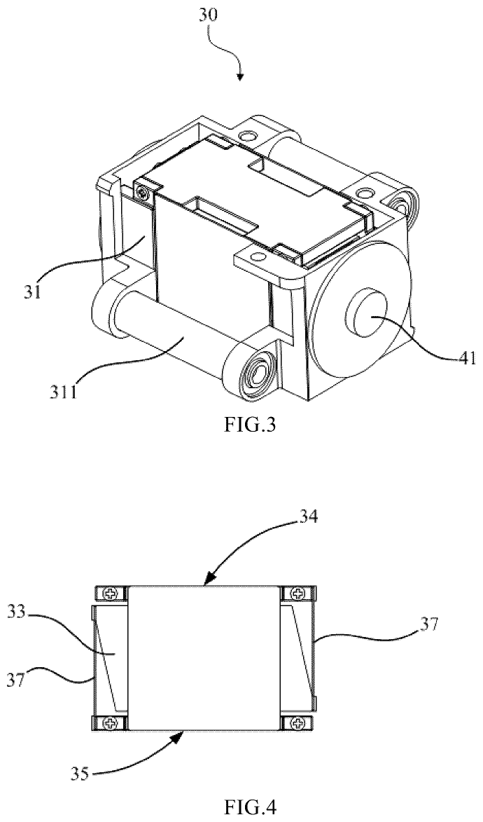

Referring to FIGS. 1 to 12, to improve the efficiency of the drive exciter 100 and reduce loss of the hardware while discretely presenting the anisotropic vibration, the drive exciter 100 provided by the present disclosure includes a bracket 10, a vibration part 30, a braking part 40 and a latch part 50, and the bracket 10 includes an installation member 11 and a guiding structure 13 connected to the installation member 11: the vibration part 30 is movably connected to the guiding structure 13 and provided with a vibratile vibration member 33: the braking part 40 includes a first end 41 and a second end 42 which are oppositely provided, the first end 41 being connected to the vibration part 30, and the second end 42 being connected to the installation member 11: the latch part 50 includes a driving member 51 connected to the installation member 11 and a latch member 53 connected to an output end of the driving member 51: wherein the drive exciter has a first state where the latch member 53 abuts against the vibration part 30 and a second state where the latch member 53 is disengaged from the vibration part 30; and in the second state, the vibration part 30 moves towards the installation member 11, and the first end 41 interacts with the second end 42 so that the first end 41 is separated from the second end 42.

In one embodiment, the installation member 11 is generally plate-shaped, and the guiding structure 13 is provided on one side of the installation member 11 and is fixedly connected to it. The vibration part 30 can be a linear resonator, and is movably connected to the guiding structure 13. The guiding structure 13 may be provided around the braking part 40 or may be provided on one side of the guiding part, which is not limited herein. Optionally, the guiding structure 13 may be one or more guiderods 131 connected to the installation member 11, and the vibration part 30 is sleeved onto the guiderod 131: the guiding structure 13 may be provided with a track groove, with the vibration part 30 slidably provided inside the track groove. Inside the vibration part 30, there is provided a vibration part 33 that vibrates in a certain direction. It can be understood that the vibration member 33 has a certain mass to possess sufficient energy during vibration.

In the present embodiment, the latch part 50 is provided on a side of the vibration part 30, wherein the driving member 51 may be a linear motor, solenoid, linear actuator, rotary motor, or other drive device, and drives the latch member 53 to approach or move away from the vibration part 30 either by translation or rotation.

The braking part 40 may be a separately arranged magnet or an integral air spring, and brakes the vibration part 30 through the interaction of the first end 41 and the second end 42.

Specifically, in one embodiment, it is necessary for the drive exciter 100 to go through the following stages to produce a complete anisotropic vibration:
energy storage stage: inputting an electric drive signal to the vibration part 30, generating an excitation magnetic field in the vibration chamber so as to drive the vibration member 33 to vibrate continuously for storing energy, and at this point the drive exciter 100 is in the first state, and the latch member 53 abuts against the side surface of the vibration part 30 to relatively fix the vibration part 30 in the vibration direction of the vibration part 33;
releasing stage: the driving member 51 drives the latch member 53 to translate or rotate until the latch member 53 is disengaged from the vibration part 30, causing the drive exciter 100 to transition to the second state;
motion stage; at this point, the drive exciter 100 is in the second state. The vibration part 30 is disengaged from the constraint of the latch member 53 and, under the drive of the internal vibration part 33, moves towards the braking part 40 provided on the installation member 11;
braking stage: as the vibration part 30 moves, the distance between the first end 41 and the second end 42 gradually decreases, and their mutual interaction increases. The momentum of the vibration part 30 is transferred to the installation member 11 in the form of acceleration, thereby producing anisotropic vibrations and generating a pulling sensation or force sensation along the normal direction of their contact surface;
returning stage: after the anisotropic vibration is generated once, the vibration part 30 moves away from the installation member 11, and the drive exciter 100 returns to the first state and waits for the next trigger, at which point the anisotropic vibration stops.

It can be understood that in the above embodiment, the generation of the anisotropic vibration does not originate from the vibration of the vibration part 30 itself, but rather from the cooperation between the braking part 40 and the vibration part 30. Specifically, the braking part 40 brakes the vibration part 30 to generate the anisotropic vibration, and when the vibration part 30 leaves the braking part 40, the anisotropic vibration stops.

After going through the above stages, the drive exciter 100 may generate the anisotropic vibration once. By repeating the above processes multiple times within a certain period, it is possible to discretely generate multiple instances of anisotropic vibration. Further, by controlling the motion frequency of the vibration part 30, it is possible to control the frequency of generating the anisotropic vibration. By changing parameters such as the mass of the vibration part 30 or the magnitude of the current, it is possible to change the magnitude of the anisotropic vibration.

The technical solution of the present disclosure may significantly increase the asymmetry of the anisotropic vibrations and present asymmetric vibrations discretely over a short period of time. Moreover, by generating vibrations that are close to the asymmetrical vibration force that actually occurs, it is possible to discretely present a clear force sensation in a certain direction for a short period of time, and the direction of this force sensation depends on the direction in which the braking part 40 abuts against the vibration part 30, and is no longer limited to the manner of holding.

Additionally, the present disclosure brakes the vibration part 30 through the interaction between the first end 41 and the second end 42, thereby generating anisotropic vibrations. On one hand, the vibration part 30 and the installation member 11 do not come into contact, thus reducing hardware wear: on the other hand, solid contact braking tends to be short in time, whereas by adjusting parameters such as the material, shape, etc., of the first end 41 and the second end 42, the present disclosure may achieve a longer braking time, results in diverse effects, and presents a clear sense of directional force with little unnecessary vibration.

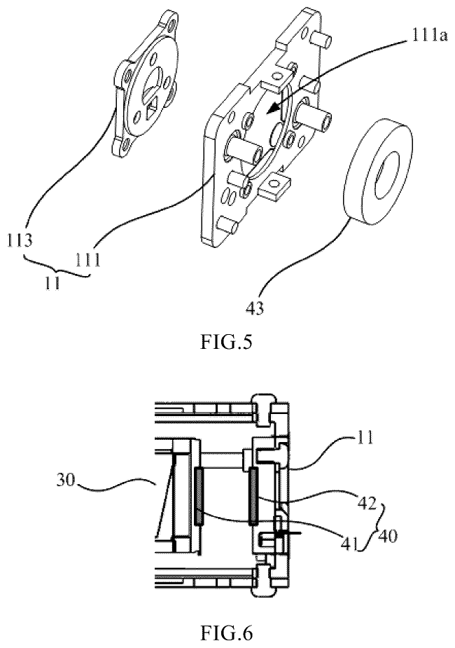

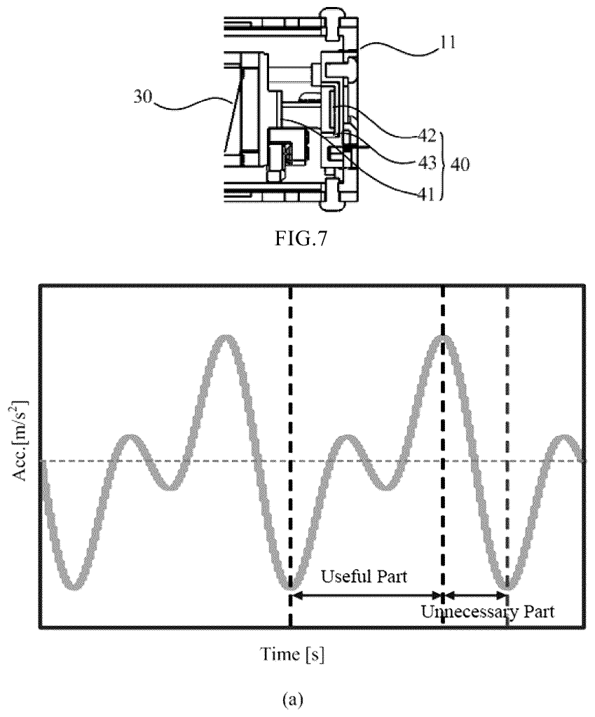

Referring to FIGS. 6 and 7, in one embodiment, the first end 41 is a first magnetic member, the second end 42 is a second magnetic member, and polarities of their respective sides facing each other are opposite. The present embodiment brakes the vibration part 30 by a repulsive force between the first magnetic member and the second magnetic member, and by referring to the figures in combination, it is not difficult to conclude that compared to a solid material, when the distance between the first magnetic member and the second magnetic member decreases, the repulsive force between the first magnetic member and the second magnetic member increases exponentially, such that although the two are not in contact, the generated anisotropic vibration has more definite directivity.

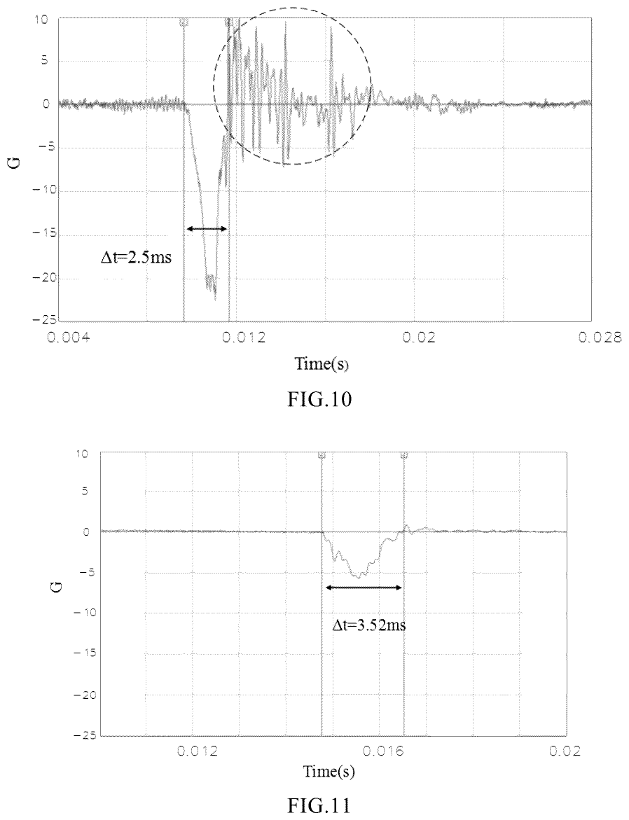

Furthermore, with reference to comparison FIGS. 10, 11 and 12, the vibrations produced by solid contact tend to be violent and short, whereas the vibrations obtained by repulsion of the magnetic poles have a regular, well-directed and longer vibration pattern.

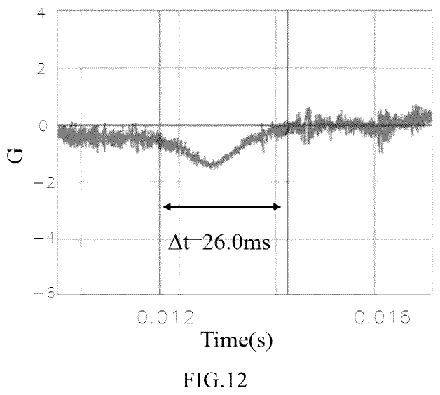

Comparing FIG. 11 and FIG. 12, after changing the size of the first magnetic member and the second magnetic member, the vibration time is prolonged, resulting in different effects.

Optionally, first magnetic member and second magnetic member are permanent magnets: of course, both of them may also be electromagnets, which is not limited herein.

Referring to FIG. 7, in one embodiment, the vibration part 30 is provided with a boss, the first magnetic member is provided on the boss, the braking part 40 is further provided with a magnetic yoke 43 connected to the installation member 11, the magnetic yoke 43 is provided with a magnetic shielding slot, and the second magnetic member is provided in the magnetic shielding slot. In this way, it is possible to reduce the magnetic flux leakage, strengthen the magnetic field, obtain a better braking effect, and improve the utilization rate.

In the embodiment of other aspects of the present disclosure, the braking part 40 is an air spring, two ends of which respectively form a first end 41 and a second end 42. When the first end 41 approaches towards the second end 42, the space in the air spring becomes smaller and smaller with the decrease of the distance, the air density increases, and the pressure also increases, so as to achieve a good vibration effect while ensuring that the first end 41 and the second end 42 are not in contact with each other.

Further, referring to FIG. 5, in one embodiment of the present disclosure, the installation member 11 includes an installation body 111 and a coverplate 113, the installation body 111 is provided with an installation groove and a clearance hole 111a provided on a bottom wall of the installation groove, the guiding structure 13 is connected to the installation body 111, the coverplate 113 seals a rabbet of the installation groove and is removably connected to the installation body 111, and the braking part 40 is fixedly connected to the coverplate 113 through the clearance hole 111a. The coverplate 113 is bolted to the installation body 111, and the second end 42 is glued or bolted to the coverplate 113. In the present embodiment, it is possible to realize the replacement of braking part 40 or the maintenance of equipment by removing the coverplate 113, which is convenient and quick.

Referring to figures, in one embodiment of the present disclosure, the latch part 50 includes two latch members 53, which are located on both sides of the vibration part 30 to form a limiting space, and the driving member 51 is connected to at least one of the latch members 53: wherein in the first state, the vibration part 30 is limited in the limiting space.

In the present embodiment, the latch member 53 may be a block-like entity or a rod-like entity. The vibration direction of the vibration part 33 is defined as the left-right direction. Optionally, the braking part 40 is provided on the right side of the vibration part 33. Two latch members 53 are spaced apart left and right to form the above vibration space. Here, the latch member 53 on the left side is fixed in place, while the driving member 51 is connected to the latch member 53 on the right side, so as to drive the latch member 53 to rotate or translate, thereby allowing the drive exciter 100 to switch between the first state and the second state.

Specifically, in one embodiment of the present disclosure, the driving member 51 is provided with a rotation shaft, the latch member 53 is a locking rod, one end of the latch member 53 is connected to the rotation shaft, and a length direction of the latch member 53 is arranged at an angle with an extension direction of the rotation shaft. In the present embodiment, the driving member 51 is a rotating motor, the latch member 53 is a substantially L-shaped structural member, one branch of the latch member 531 is connected to the rotation shaft, and the rotation shaft rotates to enable the other branch of the latch member 53 to approach or be away from the vibration part 30. When the driving member 51 receives a designated signal, the rotation shaft drives the latch member 53 to rotate, until the latch member 53 abuts against the housing of the vibration part 30 or the latch member 53 is disengaged from the vibration part 30. Thus, it is possible to simply and conveniently realize the movement of the latch member 53 and the switching between the first state and the second state.

However, in the embodiment of other aspects of the present disclosure, the driving member 51 drives the latch member 53 to move linearly, and a motion direction of the latch member 53 is arranged at an angle with the vibration direction of the vibration member 33. Optionally, the driving member 51 may be a linear motor and includes a stator and a rotor, wherein the stator is fixed in the bracket 10, the rotor is in sliding fit with the stator and moves along a straight line, and the latch member 53 is connected to the rotor. Preferably, the straight line in which the motion direction of the latch member 53 is set at an angle of 90 degrees to the straight line where the vibration direction of the vibration member 33 is located. This arrangement is simple and effective while making the generation and transmission of vibrations more explicit and achieving good results.

Of course, the driving member 51 may also be other structures that can realize the above technical concept, which is not specifically limited. Accordingly, the structure of the latch member 53 may be modified based on the structure or spatial arrangement of the driving member 51, and is not limited.

Referring to FIG. 1, in one embodiment of the present disclosure, the bracket 10 further includes a first connecting rack 15 parallel to the guiding structure 13, the first connecting rack 15 is connected to the installation member 11, and the driving member 51 is fixed to the first connecting rack 15. The latch part 50 further includes a limiting member 55, the limiting member 55 is connected to the first connecting rack 15 and forms a limiting groove 55a. The sidewall of the limiting groove 55a is formed with a notch 55b facing towards the vibration part 30. One end of the latch member 53 connected to the driving member 51 extends into the limiting groove 55a, the other end of the latch member 53 away from the driving member 51 protrudes out of the notch 55b, and the latch member 53 is rotated between two opposing sidewalls of the notch 55b.

In the present embodiment, the first connecting rack 15 is bolted to the surface of the installation member 11 and has a length direction. The length direction of the first connecting rack 15 is parallel to the vibration direction of the vibration part 33. The limiting member 55, the latch member 53, and the driving member 51 are all connected to the side surface of the first connecting rack 15. Further, to reduce the structural weight and ensure the vibration effect, the first connecting rack 15 is partially hollowed out.

In the present embodiment, the limiting member 55 is a structure similar to a bottle cap, with no specific limitations on its shape. A rabbet of the limiting groove 55a faces towards the latch member 53. The groove wall of the limiting groove 55a is provided with several notches 55b. The driving member 51 is a rotary motor. A part of the latch member 53 is provided within the limiting groove 55a, while another part passes through the notch 55b and protrudes out of the limiting groove 55a. It can be understood that the driving member 51 may drive the latch member 53 to rotate within the space between the two sidewalls of the notch 55b, and when the latch member 53 abuts against one sidewall, it also just abuts against the vibration part 30; when the latch member 53 abuts against the other sidewall, it is disengaged from the vibration part 30. By additionally providing the limiting member 55 to restrict the movement range of the latch member 53, it may be beneficial to counteract the inertia of the latch member 53 to a certain extent, and improve the working efficiency and stability of the latch member 53.

Referring to FIGS. 1, 3 and 4, in one embodiment of the present disclosure, the guiding structure 13 includes at least two guiderods 131 extending along a vibration direction of the vibration member 33, and ends of the guiderods 131 are fixed to the installation member 11.

The vibration part 30 includes a housing 31, a vibration member 33 and two elastic leaves 37. The housing 31 is provided with a shaft liner 311 at a side surface thereof, the shaft liner 311 is movably sleeved on the guiderod 131, and the housing 31 encloses a vibration space: the vibration member 33 is provided within the vibration space vibrationally; and the two elastic leaves 37 are provided on both sides of the vibration member 33 along the vibration direction of the vibration member 33, and the elastic leaves 37 are connected to the housing 31 and an end of the vibration member 33.

In the present embodiment, the housing 31 includes two end caps arranged oppositely and a connecting plate provided between the two end caps. Each end cap is provided with two mounting lugs provided on either side, and the mounting lug is provided with a clearance hole for the guiderod 131 to pass through. The mounting lugs of the two end caps are facing to each other and connected through the shaft liner 311.

The vibration part 33 vibrates in a certain direction within the vibration space. As the vibration part 33 vibrates, it simultaneously drives the elastic leaf 37 to vibrate and stores the generated energy in the elastic leaf 37. When the housing 31 approaches the braking part 40, the first end 41 and the second end 42 interact with each other, and the stored energy is released in the form of acceleration to generate a vibration wave. Since the vibration part 30 approaches the installation member 11 from one side, the resulting vibration is also one-sided and exhibits significant asymmetry. That is to say, pulling sensation in a certain direction is real and does not depend on the user's grip and sensory experience.

Further, referring to FIG. 4, in one embodiment of the present disclosure, the vibration part 30 further includes a first linkage plate 34 and a second linkage plate 35 which are oppositely provided and are fixedly connected to the housing 31. One end of the spring leaf 37 is connected to the first linkage plate 34 or the second linkage plate 35, the other end of the spring leaf 37 is connected to the end of the vibration member 33. Optionally, the vibration part 33 of the present embodiment has a substantially parallelogram cross section, the vibration direction of which is defined as the left-right direction and the up-down direction perpendicular to the left-right direction in the paper plane. The first linkage plate 34 is provided at the top, and the second linkage plate 35 is provided at the bottom. The upper left end of the vibration part 33 is connected to the second linkage plate 35, and the lower right end of the vibration part 33 is connected to the first linkage plate 34. When the vibration part 33 vibrates, its end drives the spring leaf 37 to vibrate. This configuration allows for better use of the elasticity of the spring leaf, increasing the amplitude of the vibration part 33 and the spring leaf 37 under equal conditions.

Referring to FIG. 1, in one embodiment of the present disclosure, the drive exciter 100 further includes a resetting member 60, which is a spring. The two ends of the spring are elastically connected to the vibration part 30 and a surface of the installation member 11. By providing the resetting member 60, the vibration part 30 may be smoothly reset after the braking stage, thus restoring the drive exciter 100 to the first state.

Of course, the resetting member 60 is not limited to a spring, and may be other structures capable of resetting the vibration part 30.

In another embodiment of the present disclosure, the drive exciter 100 includes two installation members 11 arranged opposite to each other, two braking parts 40 arranged opposite to each other, and two latch parts 50 arranged opposite to each other. The two ends of the guiding structure 13 are connected to the two installation members 11. The two braking parts 40 are oppositely provided on the two installation members 11. Two latch parts 50 are provided in parallel on both sides of the vibration part 30, with one driving member 51 connected to one latch member 53. Each latch member 53 is provided between the vibration part 30 and the installation member 11 to form a limiting space. Here, in the first state, the vibration part 30 is limited in the limiting space.

In the present embodiment, the two latch members 53 can be provided on the same side or on opposite sides, and both latch members 53 are movable. However, in the second state, only one of the latch members 53 moves and is disengaged from the vibration part 30. For example, when the right-side latch member 53 moves, the left-side latch member 53 remains stationary, allowing the vibration part 30 to move to the right: when the left-side latch member 53 moves, the right-side latch member 53 remains stationary, allowing the vibration part 30 to move to the left. Thus, in the second state, the vibration part 30 can only approach one of the braking parts 40, and the anisotropic vibrations generated by the vibration part 30 in cooperation with the two braking parts 40 are opposite to each other. In the present embodiment, the drive exciter 100 is capable of achieving movement of the vibration part 30 in different directions, thereby presenting two anisotropic vibrations in opposite directions. It should be noted that these two vibrations do not coexist simultaneously.

The present disclosure also relates to an electronic device, which includes the drive exciter 100 described in any of the above embodiments. The specific structure of the drive exciter 100 refers to the above embodiments. Since the electronic device adopts all the technical solutions of the above embodiments, it therefore possesses all the beneficial effects brought by the technical solutions of the above embodiments, which will not be elaborated herein.

Here, in some applications of the drive exciter 100, the electronic device may be a tactile device such as a handle or a VR all-in-one machine.

The above description is merely an optional embodiment of the present disclosure, and is not intended to limit the patent scope of the present disclosure. Any equivalent structural transformations made based on the inventive concept of the present disclosure using the contents of the specification and the accompanying drawings of the present disclosure, or their direct/indirect application in other related technical fields, shall fall within the scope of patent protection of the present disclosure.

1. A drive exciter, comprising:
a bracket comprising an installation member and a guiding structure connected to the installation member;
a vibration part movably connected to the guiding structure and provided with a vibratile vibration member;
a braking part comprising a first end and a second end which are oppositely provided, the first end being connected to the vibration part, and the second end being connected to the installation member;
a latch part comprising a driving member connected to the installation member; and
at least a latch member connected to an output end of the driving member,
wherein the drive exciter has a first state where the latch member abuts against the vibration part and a second state where the latch member is disengaged from the vibration part, the vibration part is configured to move towards the installation member, and the first end is configured to interact with the second end such that the first end is separated from the second end.

2. The drive exciter according to claim 1, wherein the first end and the second end comprise a first magnetic member and a second magnetic member respectively, with respective sides thereof facing each other having opposite polarities.

3. The drive exciter according to claim 2, wherein a surface of the vibration part is provided with a boss, the first magnetic member is provided on the boss, the braking part is further provided with a magnetic yoke connected to the installation member, the magnetic yoke is provided with a magnetic shielding slot, and the second magnetic member is provided in the magnetic shielding slot:
and/or, the first magnetic member and the second magnetic member are permanent magnets.

4. The drive exciter according to claim 1, wherein the braking part comprises an air spring, with two ends thereof forming the first end and the second end respectively.

5. The drive exciter according to claim 1, wherein the installation member comprises:
an installation body provided with an installation slot and a clearance hole provided on a bottom wall of the installation slot, the guiding structure being connected to the installation body; and
a coverplate sealing a rabbet of the installation slot and removably connected to the installation body, the second end being fixedly connected to the coverplate through the clearance hole.

6. The drive exciter according to claim 1, wherein the latch part comprises two latch members, which are located on both sides of the vibration part to form a limiting space, and the driving member is connected to at least one of the latch members;
wherein in the first state, the vibration part is limited in the limiting space.

7. The drive exciter according to claim 1, wherein the driving member is provided with a rotation shaft, with the latch member being a locking rod, a first end of the latch member being connected to the rotation shaft, and a length direction of the latch member being arranged at an angle with an extension direction of the rotation shaft:
or, the driving member is configured to drive the latch member to move in a straight line, with a movement direction of the latch member arranged at an angle with a vibration direction of the vibration member.

8. The drive exciter according to claim 1, wherein the guiding structure comprises at least two guiderods extending along a vibration direction of the vibration member, and ends of the guiderods are fixed to the installation member:
the vibration part comprises:
a housing provided with a shaft liner at a side surface thereof, the shaft liner being movably sleeved on the guiderod, the housing enclosing a vibration space, and the first end being connected to the housing;
a vibration member provided within the vibration space vibrationally; and
two spring leaves provided on both sides of the vibration member along the vibration direction of the vibration member, the spring leaves being connected to the housing and an end of the vibration member.

9. The drive exciter according to claim 1, further comprises a resetting member comprising a spring, two ends of which are elastically connected to surfaces of the vibration part and the installation member.

10. The drive exciter according to claim 1, further comprises two installation members opposite to each other, two braking parts opposite to each other, and two latch parts opposite to each other, with two ends of the guiding structure connected to the two installation members;
the two braking parts are oppositely provided on the two installation members;
two latch parts are provided in parallel on both sides of the vibration part, one driving member is connected to the latch member, and the latch member is provided between the vibration part and the installation member to form a limiting space;
wherein in the first state, the vibration part is limited in the limiting space.

11. An electronic device, comprising a drive exciter according to claim 1.
